(19) United States
(12) Patent Application Publication
(10) Pub. No.: US 2004/0015718 A1
(43) Pub. Date: Jan. 22, 2004

(54) Framework for collaborative suppression of undesirable computer activity

(75) Inventor: Eric Lewis DeClouet, Apple Valley, MN (US)

Correspondence Address: ERIC L. DECLOUET, 13195 GEMSTONE COURT, APPLE VALLEY, MN, 55124, US

(73) Assignee: HostSentinel, Inc., Apple Valley, MN

(21) Appl. No.: 10/064,178

(22) Filed: Jul. 22, 2002

(51) Int. Cl. G06F 11/30

(52) U.S. Cl. 713/201

(57) ABSTRACT

A method to accomplish the collaborative suppression of undesirable activity on any node within a computing environment through (1) the detection of a compromise event; (2) subsequent publication of a compromise event notification and (3) resulting service provider node responding to any subsequent service request from a compromised node (identified in the aforementioned compromise event notification) with one, or more, suppressive responses.

### BACKGROUND OF INVENTION

The subject of “malware” (viruses, worms, trojan horses, etc.), and more generically undesirable activity potentially by valid, authenticated users, has been quite prominent within the computing industry recently. For the sake of brevity, in the following text this document uses the term malactivity to represent all sorts of undesirable activity including that performed by malactivity and that performed by valid users.

In general, the industry has come to the conclusion that it is very difficult, if not impossible, to perfectly guard against all forms of malactivity. It is even more difficult to perfectly guard against undesirable activity by valid, authenticated users. As a result the industry has developed a number of alternative techniques to be used in concert to combat the diversity of malactivity that have arisen and the threat of undesirable activity by valid users. However, there is the realization that even the combination of these alternatives will not preclude an organization's infrastructure from falling victim to these threats. A brief survey of those alternatives, and their primary vulnerabilities, follows.

Intrusion Detection Services (IDS) is one of the alternatives employed in addressing the tide of malactivity. It is available in two generic forms, host-based and network-based. Host-based IDS focuses on detecting unauthorized access (or attempted unauthorized access) to specific hosts on a network. Network-based IDS focuses more on the detection of unauthorized or suspicious traffic on a network. The major issue in deploying IDS has been the detection and/or prevention of “false-positives”. These are false alarms triggered when an authorized access attempt triggers the IDS monitor alert for unauthorized activity. IDS monitors can be engineered to “learn” over time, but in general the industry realizes that the issue of “false-positives” will continue to plague this alternative. This realization essentially precludes organizations, in most cases, from implementing the most austere implementations of IDS (because it precludes legitimate access) thereby limiting the effectiveness of IDS to stem the tide of malactivity.

Signature-based malactivity detection is the predominate form of anti-malactivity practiced throughout the industry. It is the primary technique employed by such first-tier vendors as Symantec (Norton Anti-Virus) and McAfee. It has now become evident that even the best signature-based technology is still reactive in its ability to stem the proliferation of malactivity. By “reactive” it is meant that some computing resource has to be attacked by a specific malactivity implementation before a signature can be identified and a counter-agent developed. The primary problem with this anti-malactivity alternative is that even the most potent implementation (for example the IBM/Symantec Digital Immune System) is incapable of proactively (before a specific malactivity attack) addressing the propagation and nefarious activity of a new species of malactivity. As such, this alternative is always playing “catch-up” and the propagation of malactivity continues.

Behavior-Blocking is a relatively recently introduced technique for “proactively” addressing the nefarious behavior of malactivity. Behavior-blockers essentially profile a computer and define what “actions” should be allowed to occur on the machine (where action is defined by event-actor intersections, essentially execution control lists). Any action not “authorized” by the behavior blocker is effectively precluded. (In some cases the Behavior-blocker, upon detection of an authorized action, will query the user for overriding confirmation of their intent to execute the unauthorized action.) In general this alternative's Achilles' heel is another form of false-positive alerts. Behavior-blockers, in general, authorize activities based upon the presence of already existing applications in the environment. In light of this, new applications—or more importantly, mobile applications downloaded from the internet, generally cause the behavior-blockers to throw an alert (at least) or block the action. The heart of the problem is that in many cases, particularly for “e-enabled organizations” the desire to run the “unauthorized application” is legitimate—hence the “false-positive”. This tendency to throw false-positives engenders the user community to disregard the behavior-blocker's alerts and “automatically override” it's attempts to block unauthorized activities. As a result the effectiveness of Behavior-blockers is compromised and the propagation of malactivity continues.

Honey-Pots (or the implementation thereof) is not explicitly another anti-malactivity alternative utilized within the industry but included in this background to illustrate the intent of their use. The objective of a Honey-Pot is to establish a tempting target which will, hopefully, attract the efforts of those agents interested in propagating malactivity. The intention is to “learn” the attacking pattern from episodes of its use in gaining access (or attempting to do so) to the Honey-Pot, and subsequently use what is learned to defend the true computing resources of the organization. From one perspective, this attempts to address the “reactive nature” of the signature-based anti-malactivity alternatives. However, whereas Honey-Pots are effective at discovering new patterns of attack they offer no anti-malactivity capabilities themselves and therefore, for the purposes of this invention, are not included in the list of anti-malactivity alternatives.

In general, this background provides testament to the fact that the industry recognizes that there is no panacea against the tide of malactivity propagation. There is no one solution, or even combination of solutions, which will preclude computing resources from becoming infected by new species of malactivity. This invention accepts the notion that new species of malactivity will continue to emerge and will continue to affect computing resources. It offers a new framework for the collaborative suppression of malactivity, through the implementation of service request restrictions and denials to “compromised computing resources”. Consider that any anti-malactivity capability is actually composed of two parts. The first part is malactivity detection (the act of identifying the circumstances that manifest the compromise of an environment by some form of malactivity). The second part of an anti-malactivity capability is malactivity suppression or removal (the act of abating or precluding the nefarious activities of malactivity and/or impeding or precluding the propagation of malactivity). This invention is specific to malactivity suppression and is designed to integrate with malactivity detection capabilities currently available in the industry.

In general, and for the purpose of understanding this invention, it is convenient to consider a canonical computing infrastructure ( a network or even a single PC) as a conglomeration of service providing resources and service consumers. Explicit examples of providers in a networked environment include email servers, network storage provides, and even the routing and switching components of the network itself. Explicit examples of providers in a non-networked environment (say a desktop PC) include the storage subsystem (disk drive(s) and associated controller(s)), the network interface, and the operating system itself (although it can be considered both a provider and consumer). Explicit examples of consumers would include the “clients” (components requesting the services of) of the providers mentioned above.

Furthermore, for the purpose of understanding this invention, consider a species of malactivity as a service consumer. It typically requests of some email server that it be emailed to its next victims. It typically requests of some storage infrastructure access to files. This invention defines a framework by which any and/or all service providing resources within an arbitrarily defined infrastructure would handle the service requests from a “compromised consumer” and suppress the activity and spread of the contaminating element. []In this patent application, components that accomplish this “malactivity detection” are generically referred to as “compromise detectors”. In the framework of this invention these compromise detectors provide (1) detection of malactivity and (2) notification of compromise events to service providers. Compromise events are, as the name suggests, those events in which some compromise of the environment is detected or suspected.

The advantages this invention offers over other malactivity suppression alternatives currently available in the industry are as follows. The first advantage is its immediacy (there need be no delay in affecting the “suppressive response” to a service request from a compromised service consumer). A second advantage is the variability of its response, allowing the response to be tailored (at run-time or before) to the specific nature of the compromise and the offerings of the service providing resource. A third advantage is its integrability with one or more malactivity detection capabilities (compromise detectors), thereby offering a better quality of response to compromise events and threats. A fourth advantage is this invention's open architecture. This invention imposes no restriction on the offerings of service providing resources or the specific “suppressive responses” implemented by service providing resources. It imposes no restriction or requirement on the communication protocol between the nodes nor does it impose any restriction on the characteristics of the service consumer nodes.

### SUMMARY OF THE INVENTION

It is the object of this invention to provide a framework through which disparate computing components, potentially from differing vendors, can participate in what this invention defines as Collaborative Suppression of Undesirable Computer Activity. In lay terms, this means that this invention provides a framework through which disparate computing components can collaborate to suppress the activity and propagation of computer malactivity. This suppression is accomplished through the denial, by service providing components, of a response to a service request from any component that has been identified as compromised. (As an alternative to denial of a response, components can also respond with specialized “suppressive responses” which have been engineered to attenuate undesirable activity.)

Furthermore, it is the object of this invention to define a minimum architecture necessary for a generalized collection of computing components to accomplish the collaborative suppression described above.

Furthermore, it is the object of this invention to define a minimum protocol necessary for a generalized collection of computing components to accomplish the collaborative suppression described above.

### BRIEF DESCRIPTION OF DRAWINGS

FIG. 1 is a block diagram of a generic network, non-communication protocol specific, showing relationships between a network of five (5) nodes. This hypothetical network is composed of one (1) service consumer and four (4) service providers. Note that compromise detectors can exist on either service provider or service consumer nodes.

FIG. 2 is a block diagram of an arbitrary Collaborative Suppression Network. It depicts nodes that have CSN enabled compromise detectors (which are compromise detectors which have implemented the Collaborative Suppression protocol) and non-CSN enabled compromise detectors. It is instructive to notice that like compromise detectors, CSN enabled compromise detectors can exist on service provider or service consumer nodes.

### DETAILED DESCRIPTION

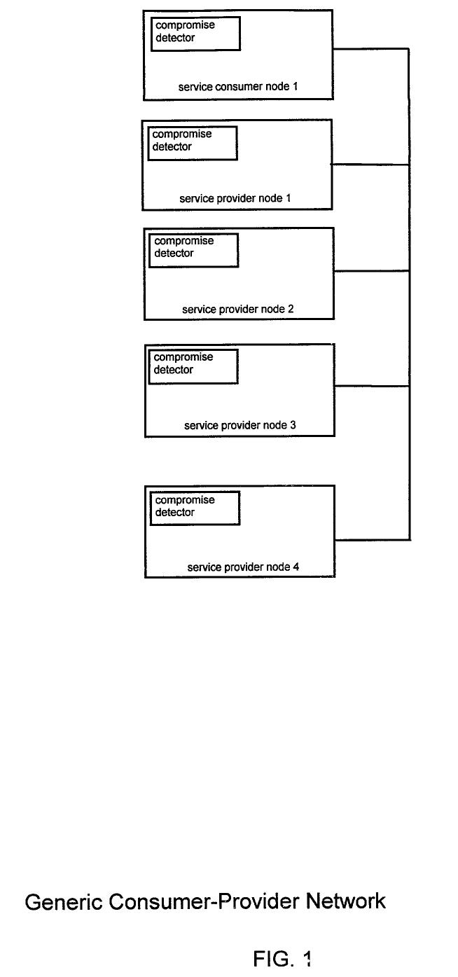

FIG. 1 shows a block diagram of an example network of computing components. The example network is composed of five (5) nodes, but in general the number of nodes is arbitrary. For the sake of understanding this invention, nodes can be classified as service providers, service consumers, or combination (both provider and consumer—depending upon the service in question). The nodes in FIG. 1 are labeled as either service provider or service consumer. The nodes are connected by some communication protocol that allows them to (1) gain awareness of one another's presence on the network and (2) allows them to communicate with at least one other node on the network. (A non-exhaustive list of examples of such communication protocols includes networking protocols (tcp/ip, ipx/spx, etc.), bus protocols (SCSI, PCI, etc.), and modem protocols (XMODEM, KERMIT, etc.)). The example of FIG. 1 does not specify a communication protocol as the invention is not specific to any particular communication protocol. What this invention provides is the minimum architecture and minimum inter-node protocol (inter-node conversations) required for an arbitrary network to accomplish the collaborative suppression of undesirable activity.

An important part of the architecture, depicted in FIG. 1 but not defined by this invention, is what is noted as a “compromise detector”. This component represents existing components in the marketplace. In general those components, in compliance with this invention, will be used to (1) detect the presence of compromise events, and (2) sending of compromise event notifications. A non-exhaustive list of example industry offerings that are potential compromise detectors includes virus detection components (Norton Anti-Virus, McAfee, etc._), behavior-blockers (Entercept, Finajn, Aladdin, etc.), network or host-based Intrusion Detection components, or even authentication components (LDAP implementations, DCE/Kerberos implementations, etc.).

[Minimum Required Architecture]

This invention defines, at a minimum, a two-tiered architecture of service consumers and service providers. (Note, compromise detectors can exist on either service consumers or service providers.) For explicit examples of service providers and consumers, see the section titled “Background of Invention”. Any node (either service consumer or service provider) on which resides a compromise detector must be able to communicate with all service providers (either directly or through an intermediary) on their network. To understand the requirements the invention places on the definition of a node, first consider the following definitions.

“Collaborative Suppression Network”—also referred to as a CSN, is defined as an arbitrary collection of nodes all participating in collaborative suppression (this invention). In general, this collection is a subset (potentially a proper subset) of the entire collection of nodes on a network.

“Collaborative Suppression Node”—also referred to as a CS Node or simply CSn is a network node that has been integrated into the Collaborative Suppression Framework defined by this invention and is hence participating in a Collaborative Suppression Network.

“Network Existence”—to say that a node exists on a network implies the following minimal conditions: (1) The node is capable of communicating with at least one other node (also said to exist) on the network. (2) The node is aware of its identification credentials on the network (i.e., network address) and is capable of communicating that information to at least one other node on the network.

“Compromise Detector”—is defined as any component designed to detect a compromise of a computing environment. There are many such examples currently available in industry. Examples of currently available compromise detectors include the industry's offerings in virus protection, intrusion detection, and behavior blocking. Note that each compromise detector defines the compromise conditions it is designed to detect, thereby defining the compromise events it can detect. This invention does not stipulate anything regarding the definition of the compromise conditions implemented by any particular compromise detector.

“CSN enabled Compromise Detector”—is defined as any compromise detector that has been engineered to implement the collaborative suppression protocol defined by this invention.

“Service Consumer”—is defined as a node which creates and sends service requests to other nodes in a network. Service Consumers may be synchronous or asynchronous in their communication mode. Particular service requests may or may not require a response from the service provider to which the request was submitted.

“CSN enabled Service Consumer”—is defined as a service consumer node which implements the collaborative suppression protocol defined by this invention. For a service consumer, implementation of the collaborative suppression protocol is limited to compromise detection, event notification, and provider node discovery.

“Service Provider”—is defined as a node which receives service requests from service consumers and accomplishes some action based upon that service request. Service Providers may be synchronous or asynchronous in their communication mode. Not all service requests require a response back to the service consumer.

“CSN enabled Service Provider”—is defined as a service provider node which implements the collaborative suppression protocol defined by this invention. A service provider is able to fully implement the protocol as it can accomplish all functions: compromise detection, event notification, provider node discovery, and service restriction. A provider can also function to detect compromise events and issue compromise notifications as a CSN enabled Compromise Detector can be implemented on a service provider node.

“Suppressive Response”—is defined as a response, implemented by a CSN enabled Service Provider, to be executed in response to a service request from a Consumer Node which has been identified as compromised through the receipt of a compromise event notification.

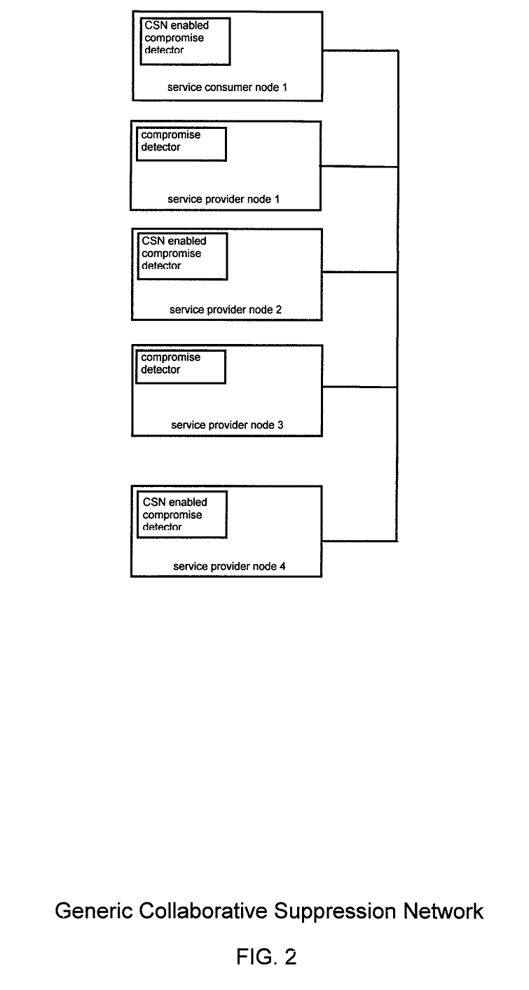

FIG. 2 shows an arbitrary CSN (Collaborative Suppression Network) depicting the generic case of not all network nodes being implemented as CS Nodes.

The invention's only requirement of the definition of either type of node (consumer or provider) is that it implement the Collaborative Suppression Protocol. To do this a node must first exist on a network Once a node exists on a network it must be able to partake in the inter-node conversations defined by the Collaborative Suppression Protocol.

[Node States and State Transitions]

There are two states attainable by service consumers; “non-compromised” and “compromised”. The non-compromised state is the normal operating condition in which service providers treat the service requests of the consumer in the normal fashion dictated by the specific implementation and configuration of the service provider. Note that the compromised state is generally a degenerate state in that each “compromise detector” will be able to identify any number of specific compromise events and event types. The classification of events is something determined by the specific implementation of a compromise detector. Consumer state transitions are accomplished in one of two ways. The transition from non-compromised to compromised is accomplished when a “compromise event notification” is sent to the service providers on the network. Sending of compromise event notifications are to be accomplished by any number of available “compromise detection” components that have been integrated with a “service consumer model or service provider model” compliant with this invention. The transition from compromised to non-compromised is accomplished when a “relax notification” is sent to the service providers on the network. Sending of relax notifications is generally the responsibility of human administrators of the network. However, the invention does allow for the automatic sending of relax notifications (i.e., relax notification is a component of the protocol).

There are, similarly, two states attainable by service providers, “alerted” and “relaxed”. (In reality these two states have degenerates since both states are relative to specific consumer components. For example, a service provider (an email server perhaps) will be transitioned to the alerted state for a specific consumer by receiving a compromise notification for that consumer.) The relaxed state is the normal operating condition in which the provider treats the service request from a consumer in the normal fashion. The alerted state is the state in which the service provider responds to requests, from a compromised node, with one or more restricted responses referred to as the provider's suppressive response. Provider state transitions are accomplished by the same mechanisms by which consumer state transitions are affected—namely, “compromise event notifications” and “relax notifications”.

(Note, this invention defines minimum required service consumer and provider models that—for the purpose of affecting compromise event notifications—are to be integrated with any number of compromise detection components. Example compromise detection components would include virus detection components (Norton Anti-Virus, McAfee, etc._), behavior-blockers (Entercept, Finajn, Alladdin, etc.), network or host-based Intrusion Detection components, or even authentication components (LDAP implementations, DCE/Kerberos implementations, etc.). In a commercial implementation it would be the responsibility of the vendor of the compromise detection component to integrate the consumer/provider model of this invention and, within their implementation, define the specific compromise events to be detected by their compromise detection component. This invention does not specify or restrict the detection capability or model of any compromise detection component. Similarly for a service provider, it would be the responsibility of the vendor providing the commercial implementation to define the specific suppressive responses executable by the component. This invention does not specify or restrict the nature of any service provider's suppressive response(s).)

[Minimum Required Protocol]

This invention defines the implementation of a protocol which, at a minimum, allows the components of the architecture to (1) discover elements and (2) transmit the state transition triggering notifications defined in the architecture above.

As such this invention's minimum required protocol defines two functions, “discover” and “notify”. The “discover” function is used (at least) by nodes, on which compromise detectors reside, to identify the locations of service providers (or the intermediaries through which service providers are reached). Consequently, service providers (or their intermediaries) must be able to respond to a “discover” notification with a confirmation of their status as a service provider or service provider intermediary. The “notify” function is used, at least, to send notifications (compromise event and [optional] relax) to service providers (or the intermediaries through which service providers are reached).

Discovery Request Requirements—it is necessary that all Collaborative Suppression Nodes equipped with one or more CSN enabled Compromise Detector be able to discover the presence of any and all CSN enabled Service Providers on a network. This may be directly or through some intermediary. The Compromise Detector enabled node should communicate a discovery request and the Service Provider must respond with, at a minimum, its network location credentials. The details of the network location credentials will depend upon the communication protocol upon which the particular Collaborative Suppression Network is implemented.

Compromise Event notification requirements—it is required that any and all CSN enabled Compromise Detector equipped nodes be able to send compromise event notifications to CSN enabled Service Providers upon detection of a compromise. A compromise notification must include the network location credentials of the node that has been judged compromised and the type of notification being transmitted.

1. a method to accomplish the collaborative suppression of undesirable activity on any node within a computing environment through (1) the detection of a compromise event; (2) subsequent publication of a compromise event notification and (3) resulting service provider node responding to any subsequent service request from a compromised node (identified in the aforementioned compromise event notification) with one, or more, suppressive responses:

2. The method of claim 1, wherein the method by which the identification of the potential for undesirable activity is accomplished by the detection of the occurrence of a compromise event and the subsequent publication of a compromise event notification.

3. The method of claim 2, wherein the specific nature of a compromise event is unrestricted and left to the specific implementation of a compromise detector.

4. The method of claim 2, wherein the detection of a compromise event and publication of an associated compromise event notification are distributed capabilities, simultaneously implementable on any (or even all) nodes of a computing environment.

5. The method of claim 1, wherein the collaborative suppression of undesirable activity is affected by the response, of service providing nodes, to service requests received from a node identified in a compromise event notification.
This is referred to as the suppressive response.

6. The method of claim 5, wherein the specific nature and count of suppressive responses of any particular node is unrestricted and left to the specific implementation of the service providing node.

7. The method of claim 6, wherein the association of one or more suppressive responses, of a particular service providing node, to one or more compromise event notifications is unrestricted and left to the specific run-time configuration of the service providing node.

8. The method of claim 5, wherein the collaborative suppression of undesirable activity is affected by the distributed execution of one or more suppressive responses by one or more service providing nodes.

9. The method of claim 1, wherein there is no restriction on the location, or co-location, of compromise detection and/or service provisioning to specific nodes, or on the same node; allowing for remote compromise detection and/or a single node performing compromise detection and service provisioning.
